(19) United States
(12) Patent Application Publication
(10) Pub. No.: US 2019/0135278 A1
(43) Pub. Date: May 9, 2019

(54) CONTROLLER AND METHOD

(71) Applicant: JAGUAR LAND ROVER LIMITED, Warwickshire (GB)

(72) Inventor: Richard HILLMAN, Coventry (GB)

(21) Appl. No.: 16/179,188

(22) Filed: Nov. 2, 2018

(30) Foreign Application Priority Data
Nov. 6, 2017 (GB) 1718338.5

(51) Int. Cl. B60W 30/095; B60W 30/09; B60W 50/14; B60W 40/02

(52) U.S. Cl. CPC B60W 30/0953; B60W 30/09; B60W 2050/146; B60W 40/02; B60W 50/14

(57) ABSTRACT

A controller for a collision warning system of a vehicle, wherein the controller comprises an input configured to receive first vehicle data indicative of one or more parameters of a first vehicle and target object data indicative of one or more parameters of a target object. The controller further comprises a processor configured to define a warning zone in dependence on the first vehicle data and to determine, in dependence on the target object data and the warning zone, a collision indicator. The controller further comprises an output arranged to output a control signal to a vehicle system in dependence on the collision indicator. Other aspects of the invention relate to a sensor system for a collision warning system, to a vehicle comprising the controller or the sensor system, to a method for a collision warning system, to a computer program product comprising instructions for carrying out the method, and to a computer readable data carrier having stored thereon instructions for carrying out the method.

### CROSS REFERENCE TO RELATED APPLICATION

This application claims priority to United Kingdom Application No. GB 1718338.5 filed on 6 Nov. 2017.

### TECHNICAL FIELD

The present disclosure relates to a controller and method and particularly, but not exclusively, to a controller and method for a collision warning system of a vehicle. Aspects of the invention relate to a controller for a collision warning system, to a sensor system for a collision warning system, to a vehicle comprising the controller or the sensor system, to a method for a collision warning system, to a computer program product comprising instructions for carrying out the method, and to a computer readable data carrier having stored thereon instructions for carrying out the method.

### BACKGROUND

Current vehicles, in particular automobiles, often comprise warning systems that may be used to warn the driver or other vehicle occupants of the presence of an object nearby to the vehicle. For example, a warning may be provided when the vehicle is proximal to another moving object, such as a second vehicle, or a stationary object, such as a lamp post or a recycling bin. The warning is provided to prompt the driver to control the vehicle accordingly in order to prevent collision with the nearby object. Some vehicles comprise warning systems to prevent the driver from reversing into the path of another vehicle. In these vehicles, a warning is normally triggered when the second vehicle enters a region of space behind the first vehicle.

It is particularly challenging to optimise the timing of the intervening warning. A disadvantage of warning systems currently available in vehicles is that they often intervene or trigger a warning earlier or later than necessary. For example, the warning is often triggered when there is no danger of collision, thereby resulting in the driver of the vehicle ignoring the warnings provided or deactivating the warning system completely. On the other hand, the warning provided by current warning systems may be triggered much later than required. This increases the likelihood of a collision of the reversing vehicle with a second vehicle or object. It follows that current warning systems cannot be relied upon to avoid the collision of a vehicle with a nearby object and, therefore, the use of current warning systems is limited.

The present invention has been devised to mitigate or overcome at least some of the above-mentioned problems.

### SUMMARY OF THE INVENTION

According to an aspect of the present invention there is provided a controller for a collision warning system of a vehicle. The controller comprises an input configured to receive first vehicle data indicative of one or more parameters of a first vehicle and target object data indicative of one or more parameters of a target object. The controller also comprises a processor configured to define a warning zone in dependence on the first vehicle data and to determine, in dependence on the target object data and the warning zone, a collision indicator. The controller further comprises an output arranged to output a control signal to a vehicle system in dependence on the collision indicator.

An advantage of providing a warning, which is an example of the control signal described above, to a vehicle system based on a warning zone is that the timing of the intervening warning is optimised for one or more parameters of the first vehicle, resulting in a more effective, reliable and accurate warning system. The vehicle occupants would, therefore, be less likely to ignore the warnings, and more likely to adopt the warning system in their vehicle. Moreover, the above-described controller is beneficial to vehicle occupants as it prevents early interventions and thus reduces the likelihood of the vehicle occupant becoming annoyed at the collision warning system. A further advantage is that late interventions are prevented, thereby increasing the value of the collision warning system. The controller and method described herein may be adopted for any feature intended to provide information such as a warning or autonomous emergency braking, in forward or reverse motion of a vehicle.

In certain embodiments, the one or more parameters of the first vehicle may include a velocity. In some embodiments, the one or more parameters of the first vehicle may include one or more of a position of the first vehicle, a position of the target object, acceleration of the first vehicle, acceleration of the target object, rate of change of acceleration of the first vehicle, rate of change of acceleration of the target object, and velocity of the target object. Advantageously, a wide range of parameters may be monitored, by one or more sensors in or on the vehicle, and used in the definition of the warning zone and the determination of the collision indicator. Moreover, the timing of the intervening warning may be optimised for any one or more of the above parameters of the first vehicle or the target object, enabling a more accurate warning system.

The processor may be configured to define a dimension of the warning zone in dependence on the first vehicle data. In certain embodiments, the processor may be configured to define a length of the warning zone in dependence on the first vehicle data. Optionally, the length of the warning zone may be less than or equal to a maximum threshold value. In certain embodiments, the maximum threshold value may be 6 metres. Optionally, the length of the warning zone may be greater or equal to a minimum threshold value. The minimum threshold value may be 2 metres. The length of the warning zone is determined accurately based on the first vehicle data, such as the velocity of the first vehicle. The present invention enables a warning to be provided to the first vehicle occupants for a potential collision risk which otherwise might go unnoticed if, for example, the target object was too far away from the vehicle occupant's field of view, or too close to the first vehicle to be seen. An advantage of setting a maximum threshold value and/or a minimum threshold value for the length is that it ensures the reliable use of sensors as sensor robustness may decrease at larger warning zone lengths.

In certain embodiments, the processor may be configured to determine the length of the warning zone based on at least one of a reaction distance, a braking distance and an error margin distance. Optionally, the processor may be configured to determine the length of the warning zone as a sum of the reaction distance, the braking distance and the error margin distance.

Advantageously, one or more of a reaction distance, a braking distance and an error margin distance may be taken into account by the processor when calculating the warning zone length. An advantage of considering the reaction distance, the braking distance and/or the error margin distance is that the warning zone length is calculated more accurately and reliably. A further advantage is that the length of the warning zone becomes adaptive and situationally responsive, which leads to an improved collision warning system.

The braking distance may be dependent on a braking constant and a braking gradient which may vary as a function of vehicle velocity.

The processor may be configured to define the warning zone as being rearward of the first vehicle. The present invention provides a collision warning system that enables the size and shape of a warning zone to be defined rearward of the first vehicle so that when the first vehicle is in reverse motion the collision warning system can be used to provide collision warnings to the vehicle occupants, which otherwise may be difficult due to the vehicle occupants not being able to see or envisage target objects to the rear of the vehicle.

In some embodiments, the processor may be configured to determine a time to collision for the target object in dependence on a velocity of the target object and a distance between the target object and the warning zone, and the output may be arranged to output a control signal in dependence on the time to collision being less than a predetermined threshold time.

The output may be configured to output a control signal comprising instructions for providing a warning to a vehicle occupant in dependence on the time to collision being less than or equal to the predetermined threshold time.

The warning may be one or more of visual, haptic, audial or audio-visual. It is advantageous to be able to use different types of warning for providing a collision indicator to the driver, for example, as the driver may react more promptly or more favourably to a certain type of warning and thus prevent collision. For example, one driver may prefer to use a visual-only warning, whereas another driver may prefer to use a haptic warning.

In certain embodiments, the warning may be a visual warning, and the output may be configured to output a control signal comprising instructions for switching the warning from a visual warning to an audio-visual warning in dependence on the time to collision being less than or equal to a second predetermined threshold time. This feature enables the driver or other vehicle occupant to be alerted more easily to the collision risk as the warning type changes.

In some embodiments, the output may be configured to output a control signal comprising instructions for activating a braking system in dependence on the time to collision being less than or equal to the predetermined threshold time. An advantage of this feature is that a braking system is automatically activated when a collision risk is detected, and so it does not require any additional input by the driver in order to prevent collision.

The processor may be configured to determine the predetermined threshold time based on at least one of a reaction time, a braking time and an error margin time.

The processor may be configured to determine the predetermined threshold time based on a sum of the reaction time, the braking time and the error margin time.

Optionally, the braking time may vary a deceleration rate of the vehicle as a function of vehicle velocity.

The braking time may be dependent on a braking constant and a braking gradient which may vary as a function of vehicle velocity.

In some embodiments, the processor may be configured to define a curved dimension and/or an orientation of the warning zone in dependence on a steering angle of the first vehicle and to determine, in dependence on the target object data and curved dimension of the warning zone, a collision risk; and the output may be arranged to output a control signal to the vehicle system in dependence on the collision risk. The present invention provides a way of preventing collision not only when the target object is ahead or rearward of the first vehicle, but also if a target object is present at different angles with respect to the first vehicle or moving towards to the first vehicle from different angles. The shape of the warning zone may be, for example, arc-shaped and the processor may be configured to define the arc length of the arc-shaped warning zone.

According to another aspect of the present invention, there is provided a method for a collision warning system of a vehicle. The method comprises determining first vehicle data indicative of one or more parameters of a first vehicle and target object data indicative of one or more parameters of a target object. The method also comprises defining a warning zone in dependence on the first vehicle data and determining, in dependence on the target object data and warning zone, a collision indicator. The method further comprises controlling operation of the vehicle system in dependence on the collision indicator.

In certain embodiments of the method, the method may comprise the functionality provided by the input, processor and output of the previously described controller.

The present method benefits from the same advantages as set out in respect of the preceding aspect of the invention and its embodiments.

According to yet another aspect of the present invention, there is provided a sensor system comprising a sensor for generating the first vehicle data and the previously described controller.

According to yet another aspect of the present invention, there is provided a vehicle comprising the previously described controller for the collision warning system or the previously described sensor system.

According to yet another aspect of the present invention, there is provided a vehicle arranged to carry out the previously described method of the collision warning system.

According to yet another aspect of the present invention, there is provided a computer program product comprising instructions for carrying out the previously described method.

The computer program product may comprise instructions, which when executed on a processor, configure the processor to: determine first vehicle data indicative of one or more parameters of a first vehicle and target object data indicative of one or more parameters of a target object; define a warning zone in dependence on the first vehicle data; determine, in dependence on the target object data and warning zone, a collision indicator; and control operation of the vehicle system in dependence on the collision indicator.

According to yet another aspect of the present invention, there is provided a computer readable data carrier having stored thereon instructions for carrying out the previously described method.

The data carrier may comprise instructions, which when executed on a processor, configure the processor to: determine first vehicle data indicative of one or more parameters of a first vehicle and target object data indicative of one or more parameters of a target object; define a warning zone in dependence on the first vehicle data; determine, in dependence on the target object data and warning zone, a collision indicator; and control operation of the vehicle system in dependence on the collision indicator.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic plan-view illustration of a first vehicle having a collision warning system and a rectangular warning zone rearward thereof and a second vehicle approaching the warning zone;

FIG. 2 is a chart showing the type of control signal outputted in dependence on a length of the warning zone of FIG. 1 and a reversing velocity of the first vehicle of FIG. 1;

FIG. 3 is a schematic illustration of the second vehicle in FIG. 1, with a view from inside the first vehicle, wherein the second vehicle is on a road approximately perpendicular and driving towards the warning zone which is rearward of the first vehicle;

FIG. 4 is a schematic illustration of the second vehicle of FIG. 3, with a view from inside the first vehicle, wherein the second vehicle is located closer to the warning zone of the first vehicle;

FIG. 5 is a schematic illustration of the second vehicle of FIG. 4, with a view from inside the first vehicle, wherein the second vehicle is located yet closer to and approaching the warning zone of the first vehicle;

FIG. 6 is a schematic illustration of the functional components of a controller configured to control operation of the collision warning system located within the first vehicle of FIG. 1;

FIG. 7 is a process flow chart outlining a method of collision warning in accordance with an embodiment of the invention;

FIG. 8 is a process flow chart outlining a method of collision warning in accordance with an alternative embodiment of the invention;

FIG. 9 is a schematic plan-view illustration of a first vehicle having a collision warning system and a curved warning zone rearward of the first vehicle, and a second vehicle approaching the curved warning zone; and

FIG. 10 is a schematic illustration of a vehicle comprising the controller of FIG. 6.

### DETAILED DESCRIPTION

The present disclosure relates to a controller and a method. The controller and method may be used for a collision warning system in a vehicle. A sensor system may comprise the controller or the method described herein. A computer program product or a computer readable data carrier may comprise the method described herein. A vehicle may comprise the sensor system, the computer program product, the computer readable data carrier, the controller or the method as described herein.

There is presented a controller for a collision warning system of a vehicle. The controller comprises an input configured to receive first vehicle data indicative of one or more parameters of a first vehicle and target object data indicative of one or more parameters of a target object. The controller further comprises a processor configured to define a warning zone in dependence on the first vehicle data and to determine, in dependence on the target object data and the warning zone, a collision indicator. The controller further comprises an output arranged to output a control signal to a vehicle system in dependence on the collision indicator.

The term ‘target object’ may comprise, but is not limited to, an object that is moving such as a second vehicle approaching the first vehicle or a stationary object such as a lamp post or a recycling bin.

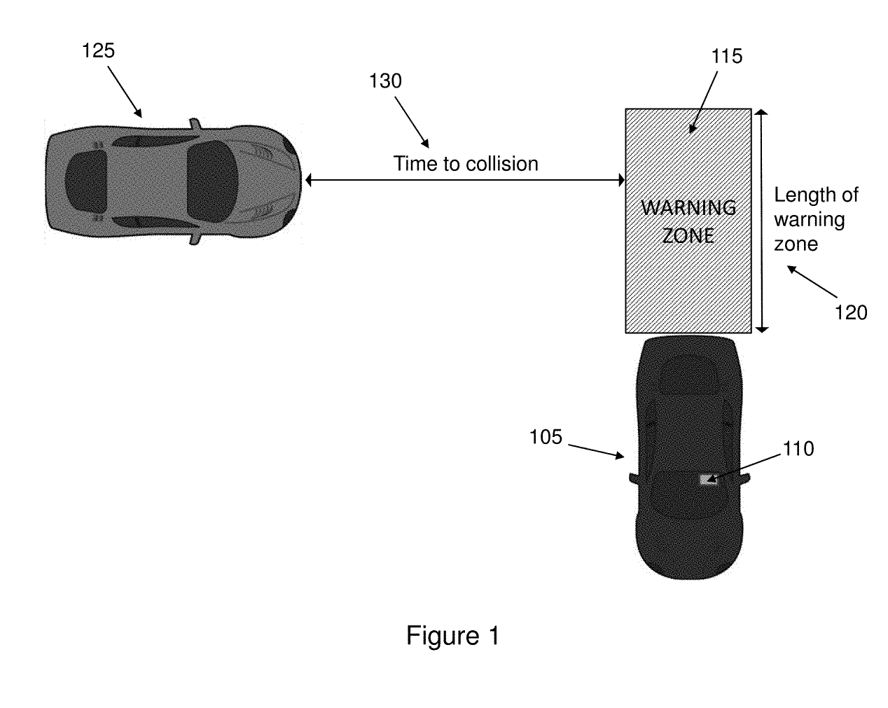

Specific embodiments of the controller and the method will be described below with reference to FIGS. 1 to 10.

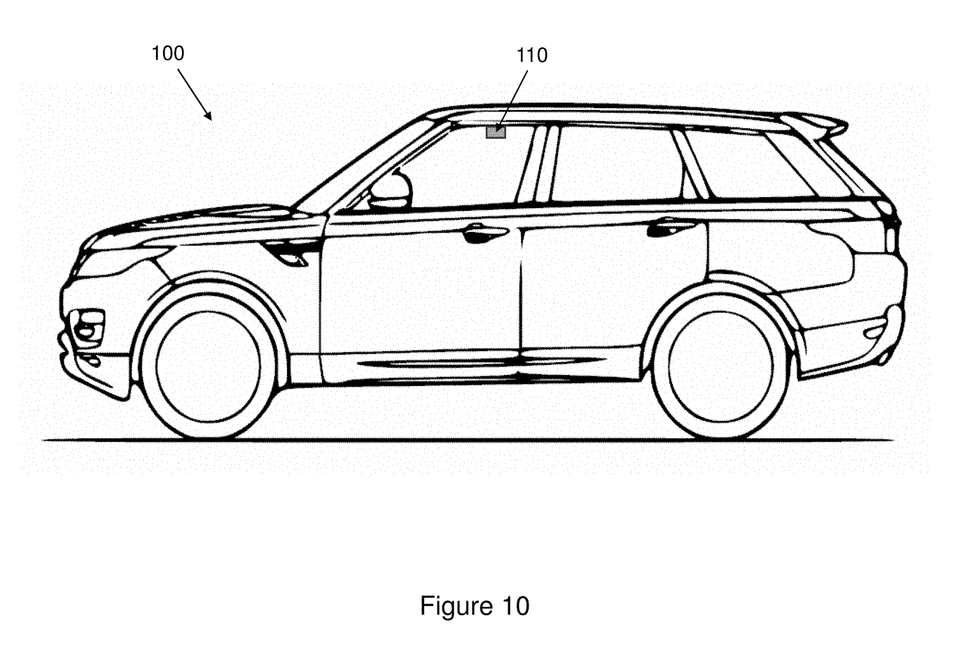

FIG. 1 is a schematic plan-view illustration of a first vehicle 105 having a controller 110 for a collision warning system, in accordance with an embodiment. The controller 110 is suitable for use in a vehicle such as the vehicle 100 shown in FIG. 10.

The controller 110 may comprise an input configured to receive the velocity of the first vehicle 105 and the velocity of a second vehicle 125. The input may be configured to receive data indicative of any one or more parameters of the first vehicle or the second vehicle wherein the one or more parameters may comprise one or more of a position of the first vehicle, a position of the second vehicle, acceleration of the first vehicle, acceleration of the second vehicle, rate of change of acceleration of the first vehicle, rate of change of acceleration of the second vehicle, and also the velocity of the first vehicle, and velocity of the second vehicle as mentioned above. A wide range of parameters including the above may be monitored by one or more sensors in or on the vehicle, and the data received by the input may be signals from a number of sensors. Additionally or alternatively, the data may be available on a memory storage means (not shown) which may form part of the controller.

The controller 110 may further comprise a processor configured to define a length 120 of a warning zone 115 in dependence on the velocity of the first vehicle 105. The warning zone 115 may be, for example, rectangular in shape and rearward of the first vehicle 105. The length 120 of the warning zone 115 may be determined based on one or more factors such as, for example, factors related to the distance required by the driver to bring the vehicle to a halt in the event of a potential collision.

The length 120 of the warning zone 115 may vary within a range of values, and/or the length 120 may be limited to a calibratable maximum threshold value and/or a calibratable minimum threshold value. The or each threshold value may be programmed at the start of use of the system, or may be adjustable in use once the system has been operated for a while and has ‘learnt’ what appropriate threshold values may be. In certain embodiments, the maximum threshold value may be in the region of 6 metres, or slightly less or slightly more. A maximum threshold value of the length 120 of the warning zone 115 may be necessary to take into account a decrease in the ability of one or more sensors on the first vehicle to detect the presence of the target vehicle as the distance between the sensor(s) and the target vehicle increases beyond the maximum threshold value.

In certain embodiments, the minimum threshold value may be in the region of 2 metres, or slightly less or slightly more. A minimum threshold value of the length 120 of the warning zone 115 may be necessary due to inaccuracy in the ability of one or more sensors to detect the precise heading angle of the target vehicle close than the minimum threshold value.

The factors used to determine the length 120 of the warning zone 115 may comprise at least one of a reaction distance, a braking distance and an error margin distance. The reaction distance may be defined as the distance allowed for the driver to understand a warning provided by the collision warning system and to place their foot on the brake pedal. The braking distance may be defined as the distance required to bring the vehicle to a standstill using a comfortable deceleration rate, that is a deceleration rate that does not place the passengers of the vehicle at a safety risk. A reasonable threshold between comfortable braking and emergency braking may be approximately 4 ms⁻². It is to be understood that this threshold, and thus the comfortable deceleration rate, may vary in dependence on one or more properties of the vehicle or preference of the vehicle occupants. The error margin distance may be defined as a constant distance included to provide an error margin.

In certain embodiments, the length 120 of the warning zone 115 may be determined as a sum of the reaction distance, the braking distance and the error margin distance, as shown in Equation (1) below.

$$Length of warning zone = reaction distance + braking distance + error margin distance = {t}_{r} {v}_{h} + \frac{{v}_{h}^{2}}{2 ( {a}_{h 0} + {v}_{h} {a}_{hg} )} + {E}_{h} \qquad ( 1 )$$

In Equation (1), tᵣ represents reaction time, vₕ represents the velocity of the first vehicle 105, aₕₒ represents a braking constant of the first vehicle 105, a_{hg} represents a braking gradient of the first vehicle 105, and Eₕ represents the error margin.

Once the length 120 of the warning zone 115 is defined, the processor may be configured to determine a time to collision for the second vehicle 125 in dependence on the velocity of the second vehicle 125 and a distance between the second vehicle 125 and the warning zone 115 or at least a portion of the warning zone 115.

The controller 110 may further comprise an output arranged to output a control signal to a vehicle system, such as an audio system or an infotainment system, in dependence on the time to collision of the second vehicle being less than the predetermined threshold time to collision for the second vehicle. The control signal may be an audial signal through, for example, the speaker system of the vehicle, a visual signal provided via a screen on the dashboard of the vehicle, or a haptic signal provided through the steering wheel. In some embodiments, a combination the above control signals may be used. The control signal provides a collision warning to the driver or any of the other vehicle occupants of the first vehicle and thus enables the driver to control the vehicle appropriately, for example by placing their foot on the brake pedal or by steering in a different direction, in order to prevent collision with the second vehicle 125.

The present invention provides a way of varying the length of the warning zone, allowing it to be tuned to provide optimal alerts to the driver to take into account the velocity of the vehicle. Advantageously, the warning zone is thus optimised in dependence on vehicle speed. The level of detail and complexity in the determination of the warning zone may be varied. More complex approaches may allow more accurate modelling of various scenarios.

Equation (1) above may be adapted to be dependent on other factors of the first vehicle 105 such as acceleration, jerk or jounce, as well as position and velocity of the first vehicle. As an example, if the first vehicle 105 is accelerating in reverse compared with driving at a constant velocity, the distance travelled during the reaction time would be higher, and the braking distance would increase as the velocity of the first vehicle 105 would be higher by the time braking commences.

In certain embodiments, the warning zone may adopt different shapes and sizes, and the processor of the controller may be configured to define different dimensions of the warning zone. For example, the warning zone may be spherical and the processor of the controller may be configured to define a diameter of the spherical warning zone in dependence on the velocity of the first vehicle. In some embodiments, for example, the warning zone may be in front of the first vehicle or sideward to the first vehicle.

In some embodiments, in order to avoid a warning being provided in a first vehicle where there is no risk of collision with a second vehicle, the warning zone length may increase as a function of velocity of the first vehicle up to a maximum length of the warning zone 115 after which it may remain at a constant value. This may be beneficial, for example, to avoid a warning if the second vehicle is too far behind the first vehicle to be a collision risk or if the second vehicle is in a separate lane to the first vehicle. The warning zone length 120 may be limited to a constant value once it reaches the maximum length, such as less than or equal to 6 metres. In some embodiments, for example, the maximum length of the warning zone 115 may be limited to a higher value, for example 9 metres, or a lower value, for example 3 metres.

In certain embodiments, the processor may be configured to define a threshold time to collision of the first vehicle with the projected path of the second vehicle.

The threshold time to collision may be determined based on one or more factors such as, for example, factors related to the time required by the driver to react and bring the vehicle to a halt in the event of a potential collision. The factors may comprise at least one of a reaction time, a braking time and an error margin time. The reaction time may be defined as the time allowed for the driver to understand a warning provided by the processor and to place their foot on the brake pedal. The braking time may be defined as the time required to bring the vehicle to a halt using a comfortable deceleration rate, that is a deceleration rate that does not place the passengers of the vehicle at a safety risk. A reasonable threshold between comfortable braking and emergency braking may be approximately 4 ms⁻². It is to be understood that this threshold, and thus the comfortable deceleration rate, may vary in dependence on one or more properties of the vehicle or preference of the vehicle occupants. The error margin time may be defined as a constant time included to provide an error margin.

In certain embodiments, the threshold time to collision may be determined as a sum of the reaction time, the braking time and the error margin time, as shown in Equation (2) below.

$$Threshold time to collision = reaction time + braking time + error margin time = {t}_{r} - \frac{{v}_{h}}{{a}_{h 0} + {v}_{h} {a}_{hg}} + {E}_{h} {v}_{h} \qquad ( 2 )$$

In Equation (2), tᵣ represents reaction time, vₕ represents the velocity of the first vehicle 105, aₕₒ represents a braking constant of the first vehicle 105, a_{hg} represents a braking gradient of the first vehicle 105, and Eₕ represents an error margin. The braking constant and the braking gradient of the first vehicle may be tuned or calibrated based on calibration data acquired before the vehicle is used. As shown in Equation (2), the braking time may be dependent on a braking constant and a braking gradient which varies as a function of vehicle velocity.

The controller 110 may further comprise an output arranged to output a control signal to a vehicle system, such as an audio system or an infotainment system, in dependence on the time to collision being less than the predetermined threshold time to collision of the first vehicle with the projected path of the second vehicle. This provides a collision warning to the driver or another vehicle occupant and so enables the driver to control the vehicle to prevent collision. The warning may be provided in a variety of types such as, for example, an audial, audio-visual, visual or haptic. The type of warning provided to the driver or the vehicle occupant may vary in dependence on the warning zone length or the time to collision. For example, a second threshold warning zone length or time to collision may be defined so that if the warning zone length or the time to collision falls below the second threshold, the warning may change from a warning of one type to a warning of another type (e.g. a visual-only warning to an audio-visual warning). In this way the driver may be alerted more easily to the collision risk as the warning type changes.

In some embodiments, the control signal may comprise instructions for activating a braking system in dependence on the time to collision being less than or equal to the predetermined threshold time. The braking system may be applied when, for example, a first vehicle is reversing towards rear cross traffic, or when a first vehicle is driving forward towards front cross traffic.

In certain embodiments, the type of warning may be dependent on the length of the warning zone or the time to collision. For example, a visual-only warning may be provided if the time to collision is higher than a predefined time, whereas a dual audio-visual warning may be provided if the time to collision is lower than a predefined time.

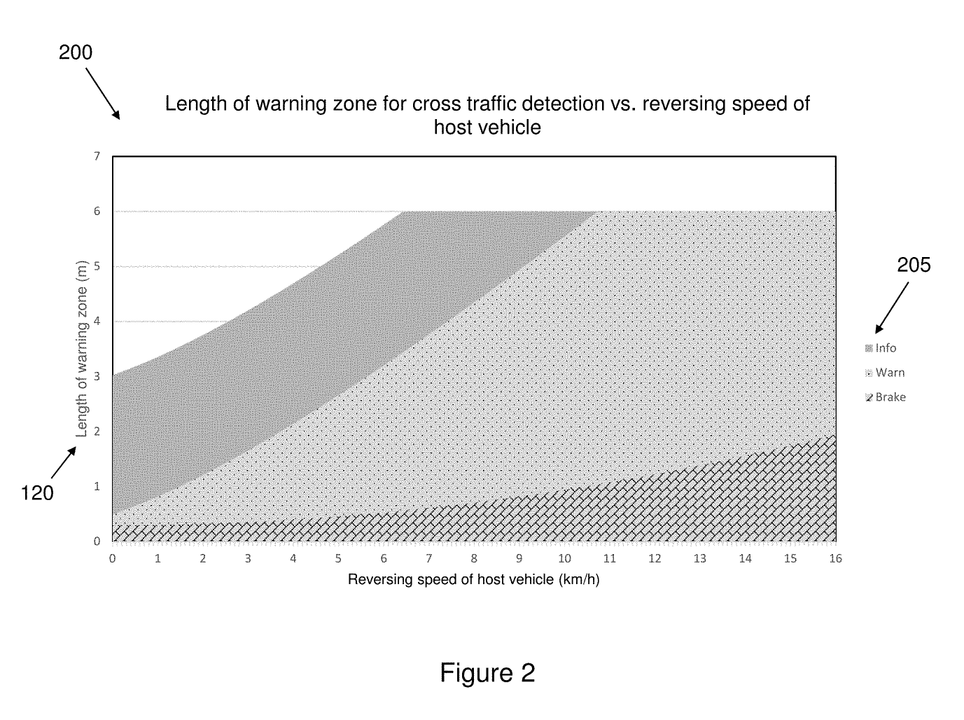

The type of warning or control signal provided may be determined and presented in a chart such as the chart 200 in FIG. 2. In FIG. 2, the type of control signal 205 provided can be seen for a specific warning zone length 120 and a reversing velocity of the first vehicle 105. In other embodiments, the warning zone length 120 and the type of warning or control signal to be provided may be determined by using look-up tables (replacing runtime computation with a simpler array indexing operation).

In some embodiments, in order to avoid a warning being outputted for vehicles with no collision risk, the time to collision may increase as a function of velocity of the first vehicle up to a maximum time to collision after which it may remain at a constant value. This may be useful, for example, to avoid a warning for a collision risk with vehicles that are too far behind the first vehicle to be a collision risk or vehicles in a separate lane. The time to collision may thus be limited to a constant value which may vary as a function of velocity of the first vehicle so that the maximum warning zone length remains constant.

The above examples describe how the warning zone length 120 and the time to collision of the first vehicle may vary as a function of the velocity of the first vehicle. A warning zone length 120 and a time to collision may be computed for the second vehicle 125, instead of or in addition to the first vehicle 105, as a function of the velocity and the position of the second vehicle 125. The processor may be configured to output a warning if both (a) the time to collision of the first vehicle 105 with the path of the second vehicle 125 is less than the predetermined threshold and (b) the time to collision of the second vehicle 125 with the path of the first vehicle 105 is less than a predetermined threshold.

In the calculation of the length of the warning zone or the time to collision, the deceleration rate may vary as a function of the velocity of the first vehicle.

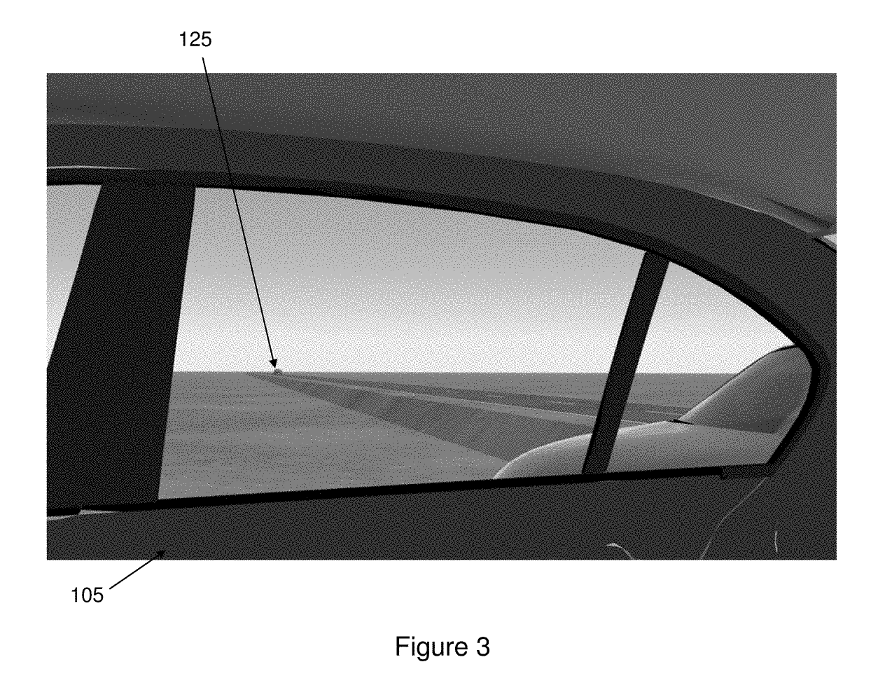

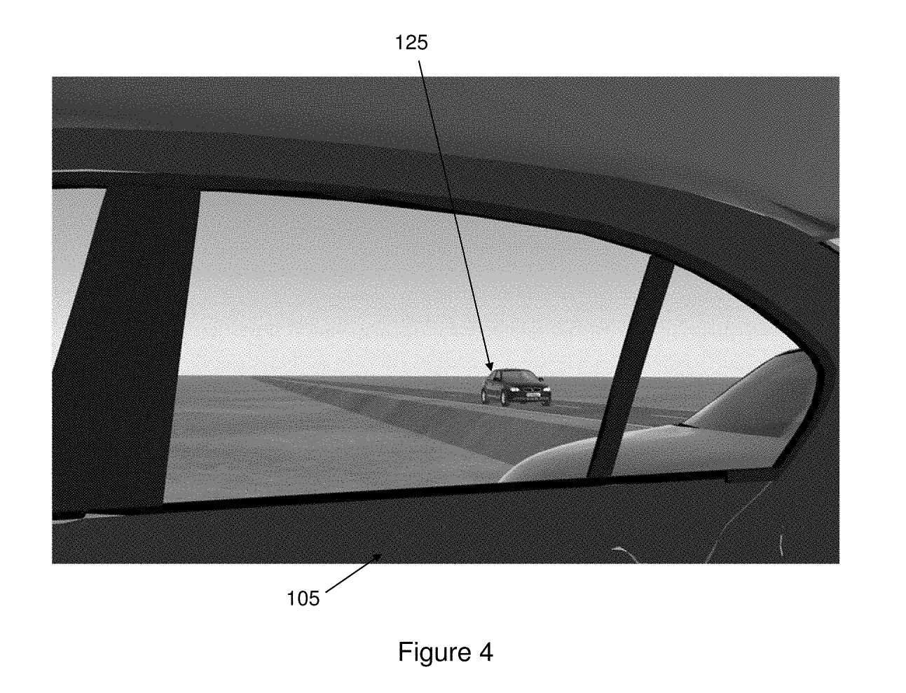

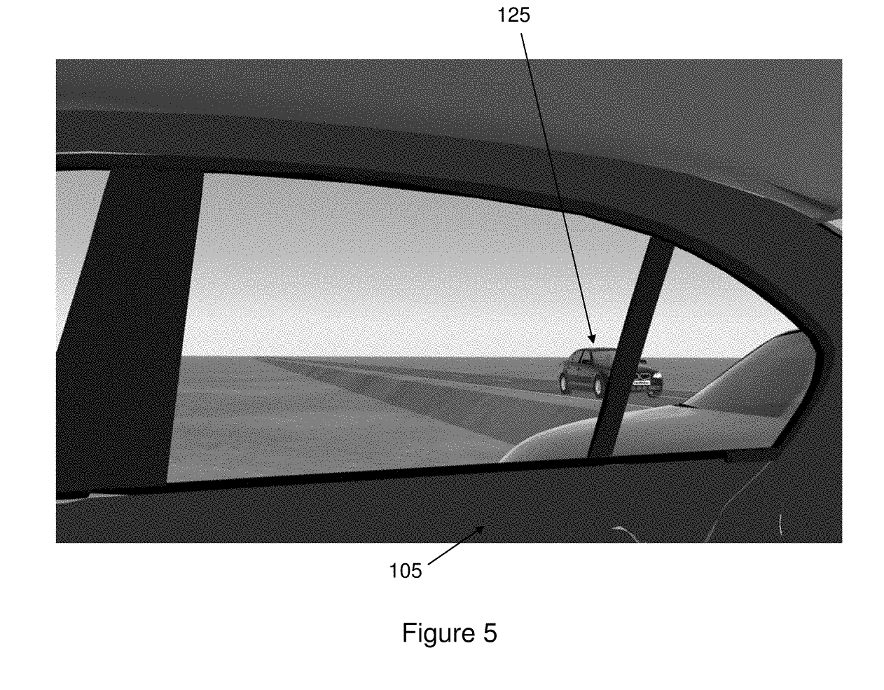

FIGS. 3 to 5 illustrate a potential collision risk scenario. Viewing the potential collision from inside a first vehicle 105, a second vehicle 125 can be seen on a road approximately perpendicular and driving towards the potential collision zone which is rearward of the first vehicle 105. The second vehicle 125 shown in FIG. 4 is located closer towards the warning zone (not shown in FIGS. 3 to 5), which may be projected behind the first vehicle 105, compared with the second vehicle 125 shown in FIG. 3. Accordingly, the second vehicle 125 shown in FIG. 5 is located closer towards the warning zone compared with the second vehicle 125 shown in FIG. 4. In one embodiment, the processor may be configured to output a warning if the time to collision of the second vehicle 125 is less than a predetermined threshold time.

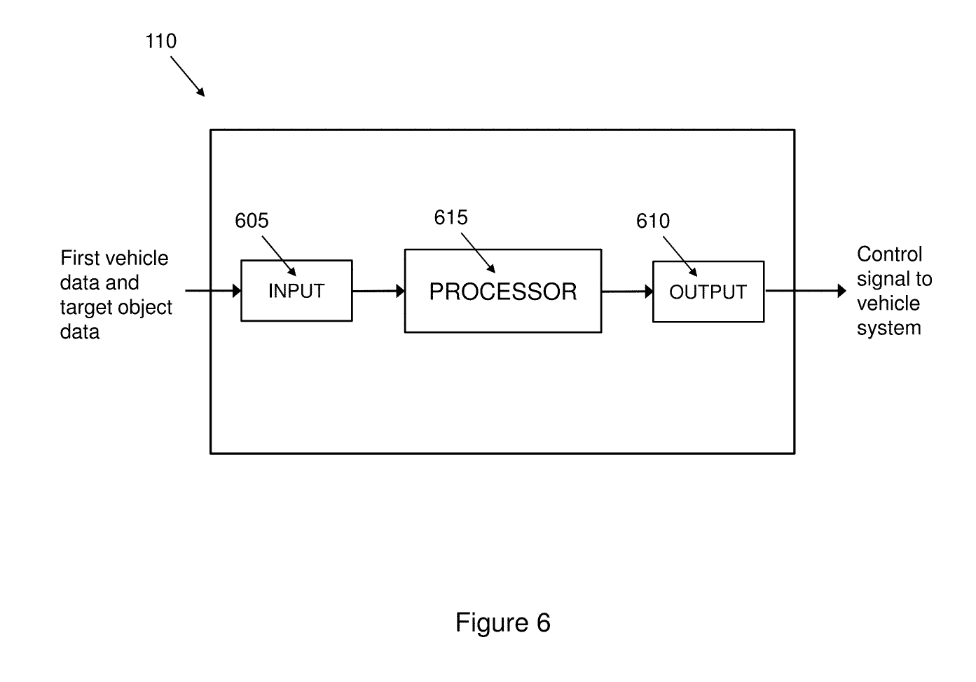

FIG. 6 is a schematic illustration of the functional components of the controller 110 forming part of the collision warning system of one embodiment of the invention. The controller 110 may be functionally embedded into an existing electronic control unit of the vehicle 100. The controller 110 may be provided with an input 605 and an output 610. The input 605 may be configured to receive first vehicle data and target object data, and the output 610 may be configured to output a control signal to a vehicle system. The control signal may be output in dependence on the time to collision being less than a predetermined threshold. Additionally, the controller 110 may comprise a processor 615 arranged to define a warning zone in dependence on the first vehicle data and to determine, in dependence on the target object data and the warning zone, a collision indicator. The processor 615 may also be arranged to generate control signals for controlling a vehicle system in dependence on the collision indicator.

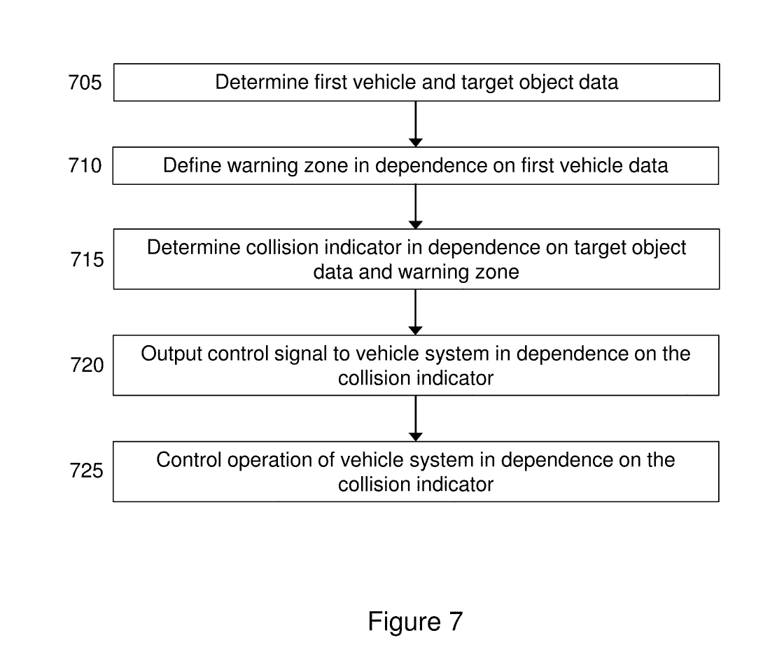

FIG. 7 is a process flow chart outlining a method used in accordance with certain embodiments of the invention, for controlling operation of a vehicle system in dependence on a collision indicator. At step 705, first vehicle data and target vehicle data, which may comprise one or more factors such as, for example, velocity, position or acceleration, are determined. A warning zone is then defined at step 710 in dependence on the first vehicle data. At step 715, a collision indicator is determined in dependence on the target object data and the warning zone. Step 720 outputs a control signal to a vehicle system in dependence on the collision indicator, after which, at step 725, the operation of the vehicle system is controlled in dependence on the collision indicator.

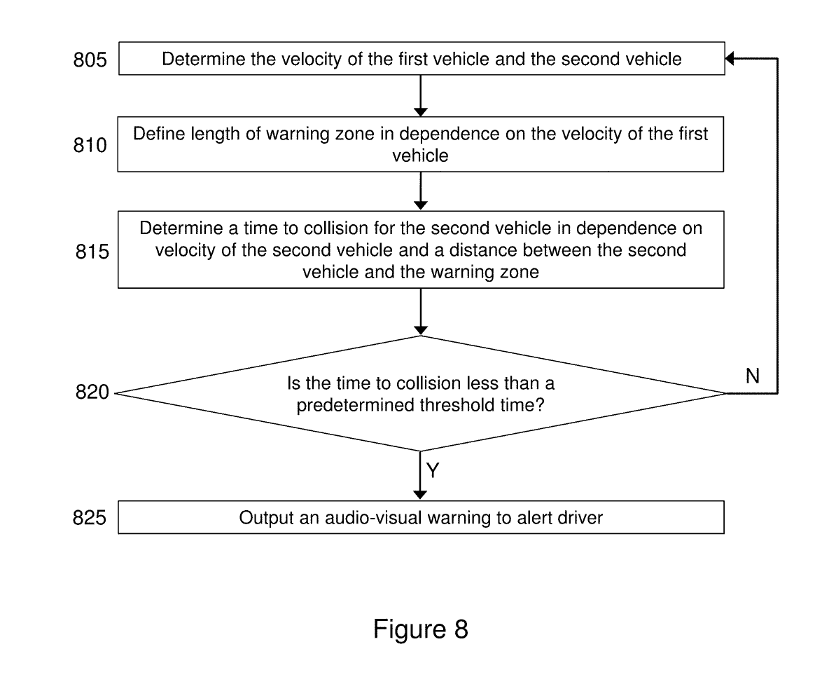

FIG. 8 is a process flow chart outlining a method used in accordance with certain embodiments of the invention, for controlling output to an infotainment system of a first vehicle which is at risk of collision with a second vehicle. At step 805, the velocity of both the first vehicle and the second vehicle is determined. A length of a warning zone is defined at step 810 in dependence on the velocity of the first vehicle. Once the length of the warning zone has been determined, a time to collision for the target object is determined at step 815 in dependence on the velocity of the second vehicle and the distance between the second vehicle and the warning zone. If the time to collision is less than or equal to a predetermined threshold time, the processor is configured to output, at step 825, an audio-visual warning to the infotainment system in order to alert the driver of the upcoming potential collision. If, however, the time to collision is greater than a predetermined threshold time, the process is repeated from step 805.

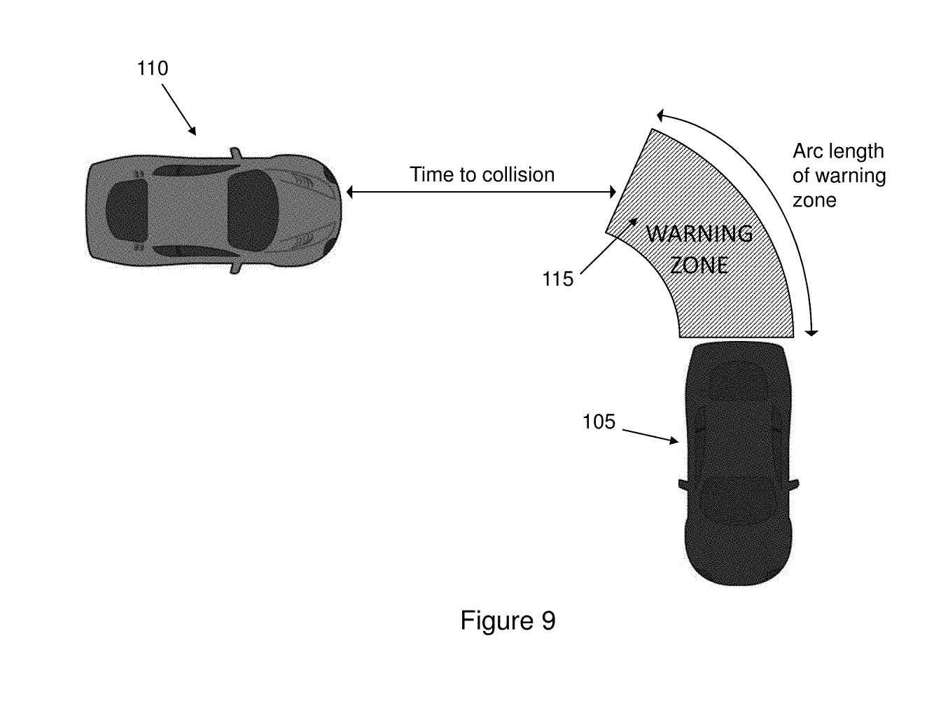

In certain embodiments, the first vehicle may have a curved warning zone rearward of the first vehicle, as shown in FIG. 9, wherein a second vehicle may be approaching the curved warning zone.

In this case, the processor may be configured to define a curved dimension and/or orientation, such as an arc length, of the warning zone in dependence on one or more parameters of the first vehicle such as, for example, the velocity of the first vehicle or the steering angle of the first vehicle. Once the arc length of the warning zone is defined, the processor may be configured to determine a time to collision for the second vehicle in dependence on the velocity of the second vehicle and a distance between the second vehicle and at least a portion of the curved warning zone.

In further embodiments, the curved warning zone dimension may be defined with respect to the second vehicle, as opposed to the first vehicle, and in dependence on one or more parameters of the second vehicle such as, for example, the velocity, position or steering angle of the second vehicle.

The controller may further comprise an output arranged to output a control signal to a vehicle system, such as an audio system or an infotainment system, in dependence on the time to collision of the second vehicle being less than the predetermined threshold time. This provides a collision warning to the driver or another vehicle occupant and so enables the driver to control the vehicle to prevent collision.

An advantage of providing a warning to the vehicle occupants based on a warning zone calculated as described above is that the timing of the intervening warning is optimised for any vehicle velocity, resulting in a more effective, reliable and accurate warning system. The vehicle occupants would, therefore, be less likely to ignore the warnings, and more likely to adopt the warning system in their vehicle. Moreover, the above-described controller and method are beneficial to the vehicle occupants as they prevent early interventions and thus reduce the likelihood of the vehicle occupant becoming annoyed at the collision warning system. A further advantage is that late interventions are prevented, thereby increasing the value of the collision warning system. The controller and method described herein may be adopted for any feature intended to provide information such as a warning or autonomous emergency braking, in forward or reverse motion of a vehicle.

It is to be appreciated that many modifications may be made to the above examples and embodiments without departing from the scope of the present invention as defined in the accompanying claims.

1. A controller for a collision warning system of a vehicle, the controller comprising:
an input configured to receive first vehicle data indicative of one or more parameters of a first vehicle and target object data indicative of one or more parameters of a target object;
a processor configured to define a warning zone in dependence on the first vehicle data and to determine, in dependence on the target object data and the warning zone, a collision indicator; and
an output arranged to output a control signal to a vehicle system in dependence on the collision indicator.

2. The controller of claim 1, wherein the one or more parameters of the first vehicle includes one or more of a position of the first vehicle, a position of the target object, acceleration of the first vehicle, acceleration of the target object, rate of change of acceleration of the first vehicle, rate of change of acceleration of the target object, velocity of the first vehicle and velocity of the target object.

3. The controller of claim 1, wherein the processor is configured to define a dimension of the warning zone in dependence on the first vehicle data.

4. The controller of claim 3, wherein the processor is configured to define a length of the warning zone in dependence on the first vehicle data.

5. The controller of claim 4, wherein the length of the warning zone is less than or equal to a maximum threshold value.

6. The controller of claim 5, wherein the maximum threshold value is 6 meters.

7. The controller of claim 4, wherein the length of the warning zone is greater than or equal to a minimum threshold value.

8. The controller of claim 7, wherein the minimum threshold value is 2 meters.

9. The controller of claim 4, wherein the processor is configured to determine the length of the warning zone based on at least one of a reaction distance, a braking distance and an error margin distance.

10. The controller of claim 9, wherein the processor is configured to determine the length of the warning zone as a sum of the reaction distance, the braking distance and the error margin distance.

11. The controller of claim 1, wherein the processor is configured to define the warning zone as being rearward of the first vehicle.

12. The controller of claim 1, wherein the processor is configured to determine a time to collision for the target object in dependence on a velocity of the target object and a distance between the target object and the warning zone; and wherein the output is arranged to output a control signal in dependence on the time to collision being less than a predetermined threshold time.

13. The controller of claim 12, wherein the output is configured to output a control signal comprising instructions for activating a braking system in dependence on the time to collision being less than or equal to the predetermined threshold time.

14. The controller of claim 12, wherein the processor is configured to determine the predetermined threshold time in dependence on at least one of a reaction time, a braking time and an error margin time.

15. The controller of claim 1, wherein the processor is configured to define a curved dimension and/or an orientation of the warning zone in dependence on a steering angle of the first vehicle and to determine, in dependence on the target object data and curved dimension of the warning zone, a collision risk; and the output is arranged to output a control signal to the vehicle system in dependence on the collision risk.

16. A sensor system comprising a sensor for generating the first vehicle data and a controller as claimed in claim 1.

17. A vehicle comprising the sensor system of claim 16.

18. A vehicle comprising the controller of claim 1.

19. A method for a collision warning system of a vehicle, the method comprising:
determining first vehicle data indicative of one or more parameters of a first vehicle and target object data indicative of one or more parameters of a target object;
defining a warning zone in dependence on the first vehicle data and determining, in dependence on the target object data and the warning zone, a collision indicator; and
controlling operation of a vehicle system in dependence on the collision indicator.

20. A non-transitory, computer-readable storage medium storing instructions thereon that when executed by one or more processors causes the one or more processors to carry out the method of claim 16.
